(19) United States
(12) Patent Application Publication
(10) Pub. No.: US 2009/0179458 A1
(43) Pub. Date: Jul. 16, 2009

(54) AUTOMOTIVE PANEL ASSEMBLY

(75) Inventor: Jeffrey S. Miki, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/013,100

(22) Filed: Jan. 11, 2008

(51) Int. Cl. B62D 25/02

(52) U.S. Cl. 296/191

(57) ABSTRACT

An automotive assembly having a rigid substructure with at least one opening. A panel having a substrate and a cushioned layer which is disposed over one side of the substrate. At least one clip extends outwardly from the other side of the substrate and the clip is complementary in shape and aligned with the opening in the substructure. An attachment mechanism secures only a portion of the outer periphery of the panel to the substructure upon insertion of the clip into its corresponding opening.

### BACKGROUND OF THE INVENTION

I. Field of the Invention

The present invention relates to an automotive panel assembly.

II. Description of Related Art

There are many panel assemblies in modern automotive vehicles which include a rigid but somewhat flexible substrate having a cushioned layer covered by a skin. For example, such panels are oftentimes used in the dashboard and other areas of the passenger compartment.

In order to complete the assembly of the automobile, it is necessary to attach these cushioned automotive panels to the substructure, e.g. the frame, of the automotive vehicle. Furthermore, in order to obtain the desired aesthetic appearance for the interior of the automotive vehicle, it is desirable for the cushioned panels to be attached to the vehicle substructure to maintain a substantially constant and predetermined gap around the outer periphery of the panel and the adjacent structure in the automotive vehicle, at least in areas of the automotive vehicle that are visible to the vehicle occupants.

Unfortunately, it is difficult to manufacture cushioned panels with a high degree of dimensional accuracy so that a constant and predetermined sized gap around the panel is difficult to obtain. One solution to this problem has been developed by Toyota in its so-called “Top Gun” system for attaching cushioned panels to the automotive vehicle substructure. In this previously known system for attaching the cushioned panel to the vehicle substructure, a plurality of spaced-apart hooks were formed around the entire periphery of the panel so that, upon insertion of the panel into the opening in the substructure, the hooks would engage a notch in the substructure and hold the cushioned panel to the substructure. Simultaneously, a notch provided on each side of each hook would engage a detent also formed in the vehicle substructure so that the combination of the hooks and notches would not only secure the cushioned panel to the vehicle substructure, but also provide a substantially constant and even gap around the panel following assembly.

One disadvantage of the previously known Toyota Top Gun panel system, however, is that it is fairly time consuming and thus labor intensive to assemble the panels to the substructure. Furthermore, although the panel may be assembled to the substructure with a constant gap around the entire panel, in many situations the gap between the panel and the substructure is not visible, or only partially visible, to the occupants of the vehicle. As such, the maintenance of a constant gap in these visibly obscured areas is unimportant.

### SUMMARY OF THE PRESENT INVENTION

The present invention provides an automotive assembly for securing cushioned panels to the vehicle substructure which overcomes the above-mentioned disadvantages of the previously known devices.

In brief, the automotive assembly of the present invention comprises a rigid substructure having at least one and preferably more spaced-apart openings. This substructure may form a part of the vehicle frame or components that are attached to the vehicle frame.

A cushioned panel is also provided having a substrate and a cushioned layer disposed over at least a portion of one side of the substrate. The substrate is typically constructed of plastic and, while rigid, is still somewhat flexible.

At least one clip extends outwardly from the other side of the substrate. Each clip is complementary in shape and size to its associated opening in the vehicle substructure. When the panel is attached to the vehicle substructure, the clip is aligned with the opening which automatically properly aligns the panel with the vehicle substructure.

A standoff is associated with each clip which limits the insertion of each clip into its associated opening and, simultaneously, limits the degree of insertion onto the vehicle substructure. Furthermore, upon full insertion of the clips into its associated openings until the standoff abuts against the vehicle substructure, a latch or spring retainer associated with each clip locks the panel to the vehicle substructure. In doing so, the panel is accurately positioned in the direction of insertion.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a fragmentary plan view illustrating a preferred embodiment of the present invention;

FIG. 2 is an exploded fragmentary view illustrating the preferred embodiment of the present invention;

FIG. 3 is a fragmentary sectional view illustrating a portion of the preferred embodiment of the present invention;

FIG. 4 is a fragmentary plan view illustrating a portion of the preferred embodiment of the present invention;

FIG. 5 is an elevational view illustrating one alignment clip;

FIG. 6 is a fragmentary sectional view illustrating a portion of the preferred embodiment of the present invention;

FIG. 7 is a sectional view taken substantially along line 7-7 in FIG. 4 and enlarged for clarity; and

FIG. 8 is a fragmentary sectional view taken substantially along line 9-9 in FIG. 7 and enlarged for clarity.

### DETAILED DESCRIPTION OF A PREFERRED EMBODIMENT OF THE PRESENT INVENTION

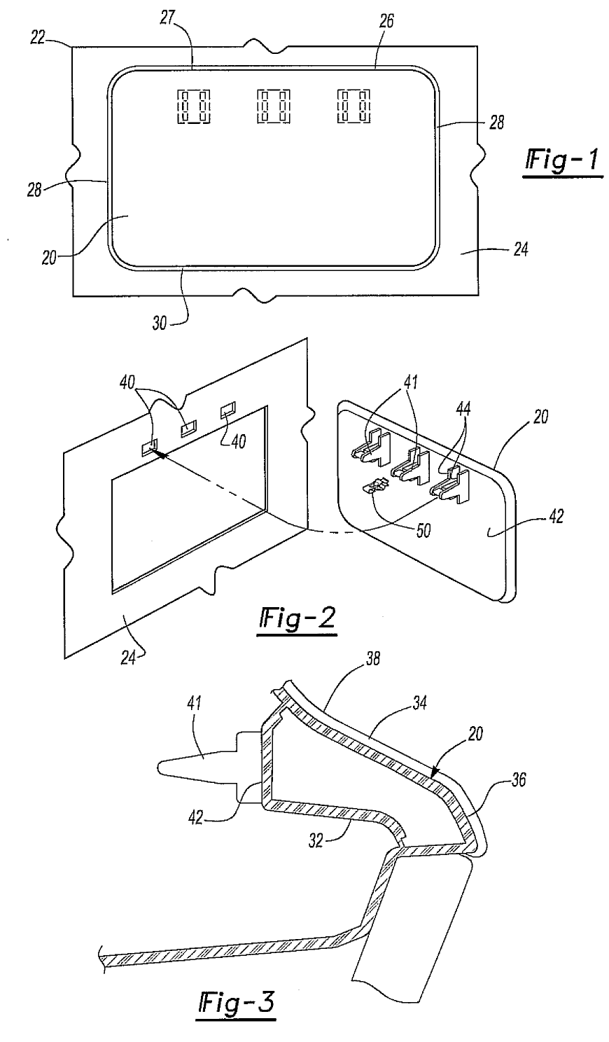

With reference first to FIGS. 1-3, a panel 20 is illustrated for use with an automotive vehicle 22, such as an interior panel in the passenger compartment. During assembly, the panel 20 is moved from a position spaced apart from an automotive vehicle substructure 24, such as the automotive frame or other components attached to the frame, illustrated in FIG. 2 and to the position shown in FIG. 1 in which the panel 20 is attached to the substructure 24. Furthermore, in order to be aesthetically acceptable, a gap 26 between the panel 20 and the vehicle substructure 24 should be maintained constant or nearly constant along the edge 27 of the panel 20 that is most visible to passengers within the passenger compartment. Conversely, with edges that are not visible, or are only partially visible to passengers within the passenger compartment, such as the edges 28 and 30, it is less important to maintain a constant width of the gap between the panel 20 and the vehicle substructure 24.

The panel 20 is best shown in FIG. 3 and includes a rigid, but flexible, substrate 32 typically made of plastic or other polymeric material. A relatively soft cushion 34 is provided along one side 36 of the substrate 32. This cushion 34 is covered by a skin 38. The cushion material 34, furthermore, is provided along at least a portion, if not all, of the side 36 of the substrate 32.

In order to properly align the panel 20 with the vehicle substructure 24, the vehicle substructure 24 is provided with at least one, and preferably more, spaced-apart alignment openings 40 (FIG. 2). These alignment openings 40 are illustrated as having a generally rectangular shape, although other shapes may alternatively be used without deviation from the spirit or the scope of the invention. The alignment openings 40, furthermore, are also preferably provided along the edge of the panel 20, which is most visible to the vehicle occupants so that a constant width gap is desirable.

As best shown in FIG. 25, in order to properly align the panel 20 with the vehicle substructure 24, at least one clip 41 extends outwardly from a rear side 42 of the panel substrate 32. The clips 41, furthermore, are preferably integrally formed with the panel substrate 32.

Referring now to FIGS. 3-5, one clip 41 is associated with each alignment opening 40 formed in the vehicle substructure 24. Each clip 41, furthermore, is complementary in shape to its associated alignment opening 40 so that, with each clip 41 aligned with its alignment opening 40 and inserted into the opening 40, the laterally panel 20 is automatically aligned with the vehicle substructure 24 as desired.

As best shown in FIG. 5, each clip 41 also includes a standoff 44. This standoff 44 abuts against the vehicle substructure 24 upon full insertion of the clip 41 into its corresponding alignment opening 40. The standoff 44 thus limits the insertion of the clips 41 into the alignment openings 40 and thus simultaneously accurately positions the panel 20 in the direction of insertion relative to the vehicle substructure 24.

With reference now to FIG. 6, a latch 50 is associated with at least one, and preferably each clip 41. The latch 50 is made of a resilient material, such as a spring metal, and has at least one outwardly projecting projection 54. Upon insertion of the clips 41 into their alignment openings 40, the latches 50 compress, as shown in phantom line, thus allowing the clip 41 and projection 54 to pass through the alignment opening 40. Conversely, upon full insertion of the clip 41 into the alignment opening 40, the latch 50 returns to its original uncompressed position thus entrapping the vehicle substructure 24 in between the projections 54 and the standoff 44 thus locking the clip 41 and its attached panel to the substructure 24.

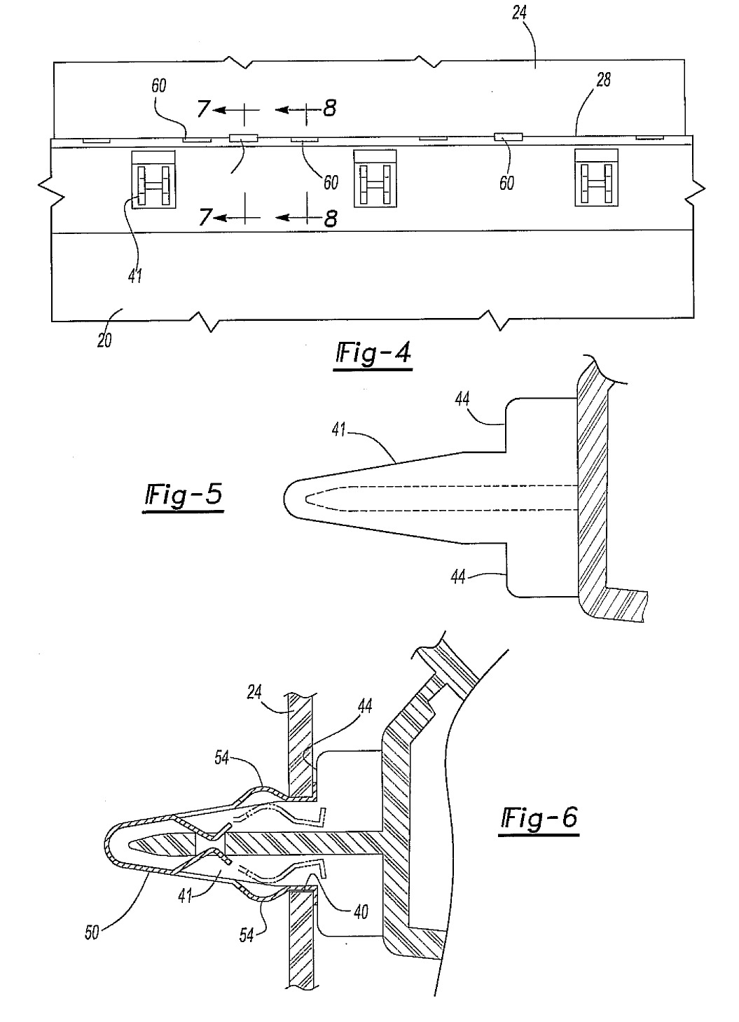

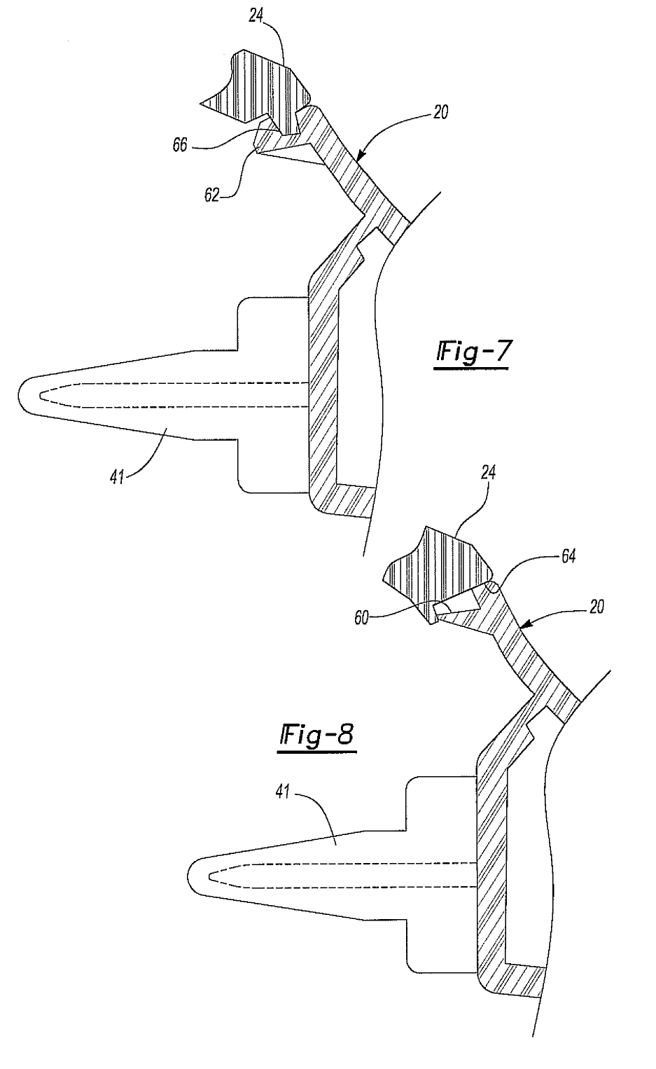

Referring now to FIGS. 4, 7 and 8, along at least one edge of the panel 20, and preferably the most visible edge, the previously known Top Gun attachment system is utilized to attach at least the most visible edge 27 of the panel 20 to the vehicle substructure 24. This previously known attachment system includes a pair of notches 60 that are spaced apart from each other along the edge 27 as well as a hook 62 which is positioned in between each pair of notches 60. Upon insertion of the panel 20 onto the vehicle substructure 24 by aligning the clips 41 with the alignment openings 40, the notches 60 in the panel 20 are automatically aligned with a notch 64 (FIG. 8) in the vehicle substructure 24 and the hook 62 similarly engages a recess 66 (FIG. 7) formed in the vehicle substructure 24. It will be appreciated, of course, that the panel notches 60 and hooks 62 exert opposite forces on the cushion 20 following attachment of the panel 20 to the substructure 24. More specifically, the notches 60 push against the vehicle substructure 24 while the hooks 62 pull the panel 20 downwardly against the vehicle substructure 24. The push/pull effect on the notches 60 and hooks 62 achieves a very even and aesthetically pleasing gap 26 between the panel 20 and the vehicle substructure 24 along the most visible edge 27 of the panel 20.

A primary advantage of the present invention is that the alignment clips 41 enable the hooks 62 and notches 60 to be used only along a single edge 27 of the overall panel 20 and preferably the edge that is most visible to the vehicle passengers. As such, the overall assembly of the vehicle panel 20 to the vehicle substructure 24 is facilitated thus reducing labor cost.

From the foregoing, it can be seen that the present invention provides a simple and yet effective system for attaching padded or cushioned panels to the substructure of an automotive vehicle. Having described my invention, however, many modifications thereto will become apparent to those skilled in the art to which it pertains without deviation from the spirit of the invention as defined by the scope of the appended claims.

I claim:

1. An automotive assembly comprising:
a rigid substructure having at least one opening,
a panel having a substrate and a cushioned layer disposed over at least a portion of one side of said substrate, said substrate and said cushioned layer having an outer periphery,
at least one clip extending outwardly from a second side of said substrate, said clip being complementary in shape to and aligned with said opening,
an attachment system which secures only a portion of said periphery of the panel to said substructure upon insertion of said clip into said opening.

2. The invention as defined in claim 1 and comprising a standoff associated with each clip which limits the degree of insertion of said clips into said openings.

3. The invention as defined in claim 1 and comprising a latch associated with said clip for locking said clip to said substructure upon insertion of said clip into said opening.

4. The invention as defined in claim 3 wherein said latch comprises a spring band having an outwardly extending projection disposed over said clips, said projection engaging a surface of said substructure upon full insertion of said clip into said opening to thereby lock said clip to said substructure.

5. The invention as defined in claim 1 wherein said attachment system comprises a hook formed on said outer periphery of said panel which engages a notch on said substructure upon attachment of said panel to said substructure.

6. The invention as defined in claim 5 wherein said attachment system further comprises a notch on at least one side of each hook which engages a protruding surface on said substructure upon attachment of said panel to said substructure.

7. The invention as defined in claim 6 and comprising a notch on both sides of each hook.

8. The invention as defined in claim 1 wherein said substrate comprises a plastic material.
